(19) United States
(12) Patent Application Publication
(10) Pub. No.: US 2002/0091783 A1
(43) Pub. Date: Jul. 11, 2002

(54) Customer definable precedence and preemption for message services

(76) Inventors: Stuart Mandel Garland, Morton Grove, IL (US); Lila Elizabeth Russ, Plainfield, IL (US)

Correspondence Address: Werner Ulrich, 434 Maple Street, Glen Ellyn, IL, 60137-3826, US

(21) Appl. No.: 09/757,926

(22) Filed: Jan. 10, 2001

(51) Int. Cl. G06F 15/16

(52) U.S. Cl. 709/207

(57) ABSTRACT

Apparatus and a method for ordering the delivery of a plurality of messages to a destination telecommunications customer. Messages are received in an output gateway. If the customer is available, a message is immediately delivered. If the customer is not available, the message is stored in one of a plurality of queues, each queue corresponding to a precedence level for a received message. When the customer becomes available, stored messages are transmitted from the queue highest priority messages being transmitted first; lowest priority messages being transmitted last. Advantageously, this arrangement ensures that the most important messages are delivered to the customer as quickly as possible.

### TECHNICAL FIELD

This invention relates to precedence and preemption for telecommunications message services.

Problem:

With an ever increasing volume of telecommunications messages, including voice and voice mail, facsimile, data, E-mail, and other voice and data services, it becomes both increasingly difficult and increasingly important for telecommunications customers to be able to control their reception of communications and, especially, to make sure that important messages are brought to their attention. The prior art has not satisfactorily and economically filled this need.

Solution:

Applicants have analyzed this problem, and the characteristics of the telecommunications network, including both the conventional circuit switched public switched telephone network and the data switched Internet protocol network. In particular, the Public Switched Telephone Network (PSTN) has provided intelligent network capabilities to allow for the screening of categories of calls by blocking such calls. Calling line identification provides customers with the identity of the calling party so that they are at liberty not to accept the calls. Data traffic is usually stored in a customer terminal for the customer to peruse at his/her convenience.

Applicants have concluded that what is missing is a customer control capability for defining different precedence levels, different types of communications messages, (both voice and data), and to arrange that messages with higher precedence are delivered before messages with lower precedence. Further, for other customer defined classes of voice or data messages, the customer can define a preemption level so that a message with a preemption level will interrupt any message with a precedence level below a defined threshold. In addition, certain classes of messages, such as military messages, defined by the government are automatically assigned precedence and preemption levels so that, for example, an attack warning from an appropriately designated command center will preempt any other type of message. Advantageously, with this kind of arrangement, customers can be sure to receive the most important messages as defined by themselves and/or the government, while deferring the reception of less important messages.

In accordance with one preferred embodiment of this Application, customers can define precedence levels and preemption levels for particular classes of calls and messages. Before a call or a message is delivered, the telecommunications network checks to make sure that no higher precedence messages have been stored or are in the process of being delivered. For preemption service, the telecommunications network checks to make sure that the message currently being delivered is of a precedence level which may be preempted; otherwise, the preempting message is stored and subsequently, delivered in accordance with its precedence level. If a customer is on a voice call and a higher precedence level voice call arrives, the customer is warned, and unless the customer gives an over-ride command, the preempting call will interrupt the current call being received.

In accordance with one preferred embodiment of the invention, a unified messaging system receives both voice and data messages and stores them in common queues. The unified messaging system can convert between voice and data at the customer's request.

In accordance with one feature of the invention, messages at or above a predefined priority are alerted to the receiving customer. The alerting can be by a screen message on a PC (Personal Computer), a screen message on a message phone, a special tone (different from a call waiting tone), or a special lamp. In response to receiving the alerting signal, the called customer can interrupt his/her conversation to investigate the message.

### BRIEF DESCRIPTION OF THE DRAWING(S):

FIG. 1 is a block diagram illustrating the basic architecture of Applicants' invention; and

FIG. 2-4 are flow diagrams illustrating the method of Applicants' invention.

### DETAILED DESCRIPTION:

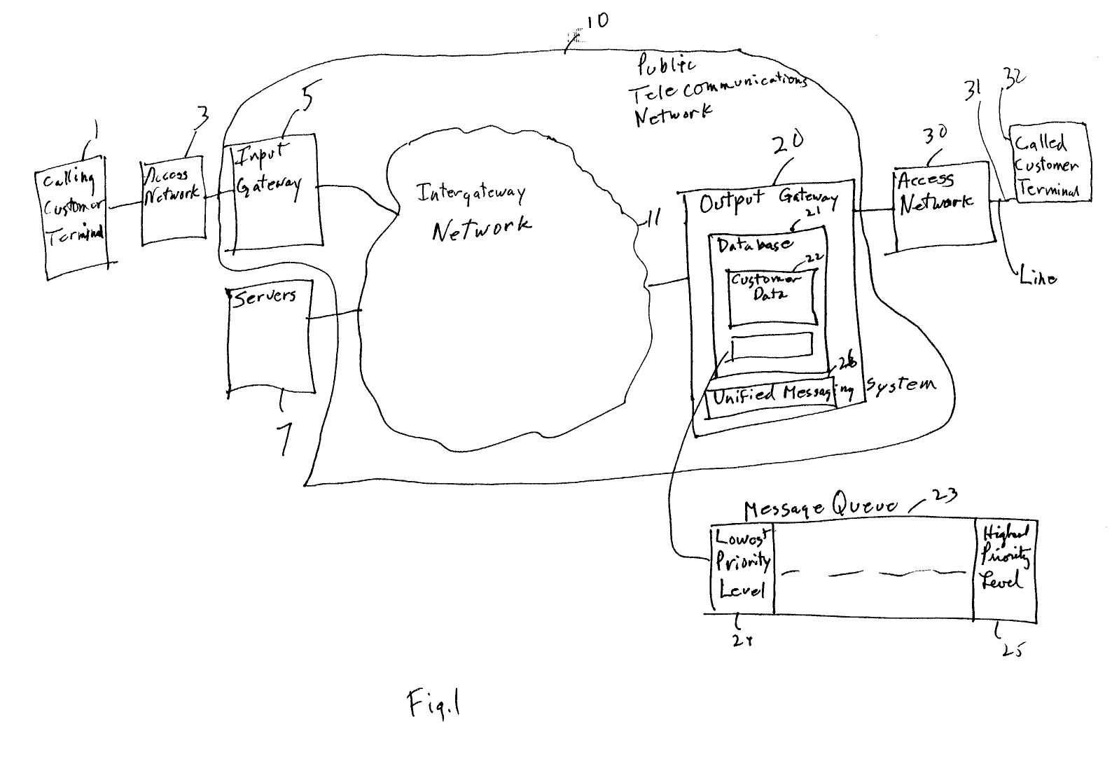

FIG. 1 is a block diagram illustrating the basic architecture of Applicants' invention. A calling customer terminal (1), or a server system (7), are connected to the public telecommunications network (10). The public telecommunications network comprises a Public Switched Telephone Network (PSTN) and an Internet Protocol (IP) Network. Both such networks can deliver data and voice traffic. The calling customer terminal (1) is connected via an access network (3) to an input gateway (5). The input gateway, which is within the public telecommunications network (10), may be an end-office switch, or may be a tandem switch. Gateways are interconnected by an Inter-Gateway Network (11). The access network may include subscriber carrier systems and/or end-office switching systems. The Inter-Gateway network is connected to an output gateway (20), which is connected via an access network (30) to a line (31) to a called customer terminal (32). The called customer terminal may be a telephone, a data terminal, some combined terminal, or a local area network gateway for serving a plurality of terminals.

The output gateway contains a database (21), which contains customer data (22) for many different customers served by the output gateway. The customer data includes, in accordance with Applicants' invention, data for characterizing calls (by the calling telephone number or a server identification), and a precedence and preemption level for each group of communication sources.

The stored precedence level is used as follows: if a communication is received and the customer is idle, the communication is simply routed to the customer. If the customer is not idle, then the communication is placed in storage. Messages from storage are delivered to the customer with highest precedence level messages being delivered before lower level precedence messages.

The output gateway contains a message queue (23), which comprises a plurality of sub-queues (24), . . . , (25). Sub-queue (24) is a sub-queue for storing lowest precedence level messages. Sub-queue (25) is a sub-queue for storing the highest precedence level messages.

Messages are received by a Unified Message System (26) which can receive both data and voice messages, and which stores such messages in the appropriate subqueue. At the request of the customer, voice messages can be delivered as text (datamessages).

If a message is received with a preemption level, then if the customer is not idle, the precedence level of the message currently being received is checked. If that precedence level is above the precedence threshold assigned to the incoming message, then the message currently being delivered is interrupted and the preemption message is immediately delivered. If the precedence level of the message currently being delivered is above the precedence threshold assigned to the incoming message, then the incoming message is stored and will be delivered in accordance with its precedence level.

In accordance with Applicants' invention, the customer can personalize his/her profile by entering data into that customer's data block (22). The data that would be entered is the data for identifying messages of each precedence class, and of each preemption and associated precedence class.

In accordance with one feature of Applicants' invention, some government messages are automatically provided with the highest precedence and preemption level so that these messages will preempt any other messages that the customer may define. Other high priority messages can be those from a stockbroker (who may have several priorities for different kinds of messages). Lowest priority messages would typically be those from a telemarketer.

In accordance with one feature of Applicants' invention, a customer can specify that routing features, such as call forwarding, call blocking, always return busy, always forward to voice mail, are to be ignored for certain classes of messages. Advantageously, with this arrangement, even though most voice calls are either not completed or are forwarded to another telephone, the calls in this category are completed to the customer's own telephone.

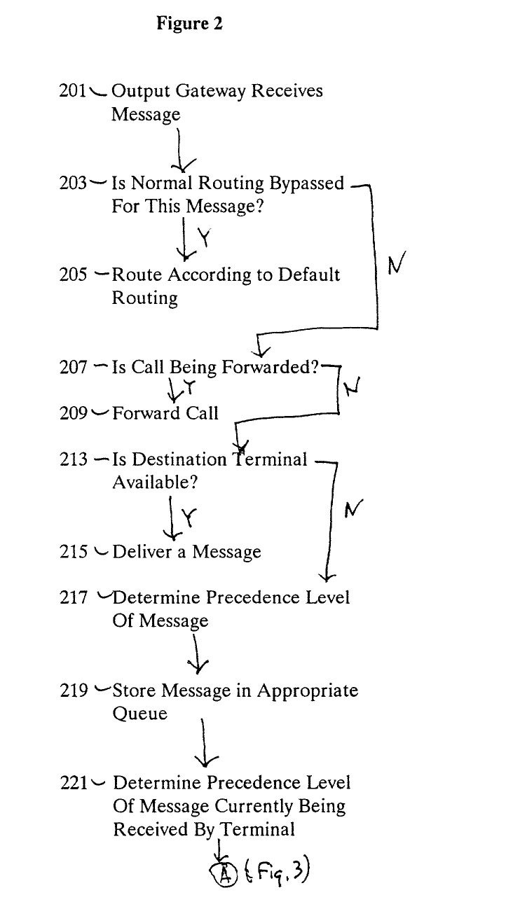

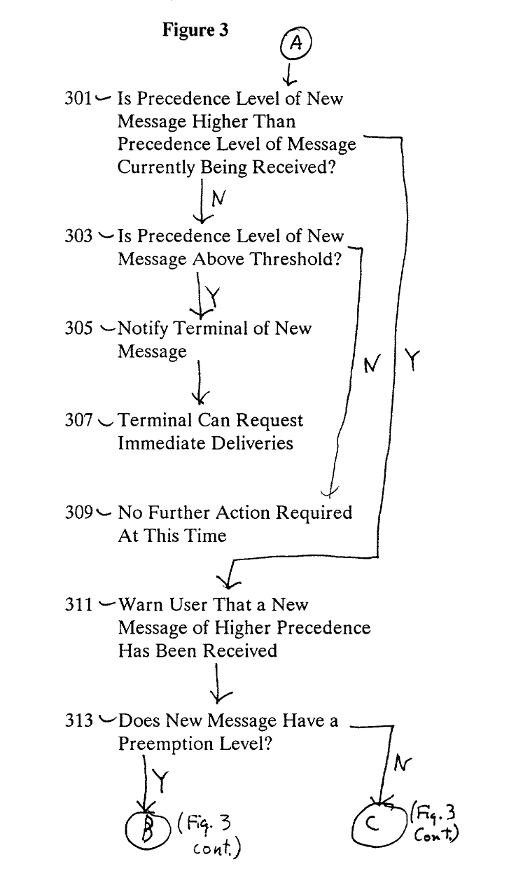

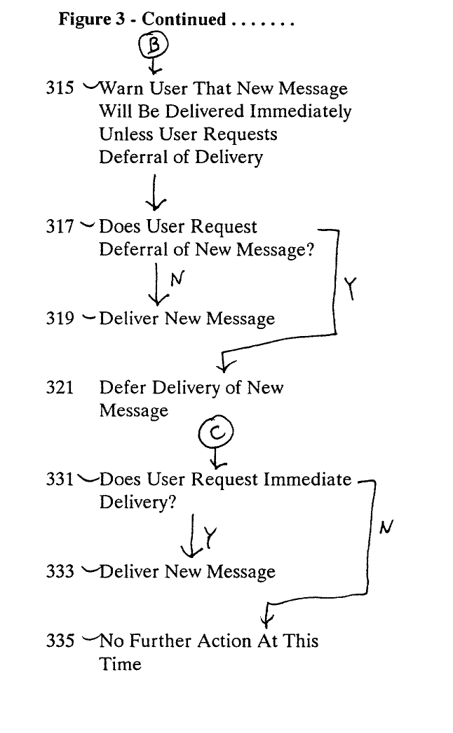

FIGS. 2 and 3 are flow diagrams illustrating the operation of Applicants' invention. The output gateway receives a message, (Action Block 201). This message may be a data message or a voice message, (i.e., a call). Test 203 determines whether normal routing should be bypassed for this message or call. In particular, if the receiving customer has call forwarding and is forwarding his/her calls, this test determines whether for this particular call, call forwarding is to be observed or to be suppressed. If the call is to be routed according to normal, i.e., default routing, then, Test 213 described below is entered. If the result of Test 203 is that normal routing is not to be bypassed for this particular incoming message, then Test 207 is used to determine whether the call is being forwarded. If the call is being forwarded, then the systems forwards the call, (Action Block 209). If the call is not being forwarded, then Test 213 is entered. Test 213 determines whether the destination terminal is available. If it is, then the message is delivered, (Action Block 215). If the destination terminal is not available, then the precedence level of the incoming message is determined, (Action Block 217). The message is then stored in a queue appropriate to the precedence level of the incoming message, (Action Block 219). Next, the precedence level of the message currently being received by the destination terminal is determined, (Action Block 221).

The flow is continued on FIG. 3. Test 301 is used to check whether the precedence level of the new message is higher than that of the message currently being received, (in this description, a high level of precedence is for important messages; a low level of precedence for unimportant messages). If the precedence level of the new message is not higher, (negative result of Test 301), then Test 303 is used to determine whether the precedence level of the new message is above some threshold. If it is above some threshold, then the terminal is notified, (Action Block 305), either by an audible signal or by the special alerting message on the destination terminal. The notification will identify the source of the new message, and can include some message control. The terminal can then request immediate delivery of the new message, or can simply continue receiving the message currently being received, (Action Block 307). If the precedence level of the new message is not above the threshold, then no further action is required at this time, (Action Block 309), since the message has been stored in the appropriate queue and will be delivered in the correct order.

If the precedence level of the new message is higher than that of the message currently being received, then a user is notified that a new message with higher precedence has been received, (Action Block 311). This notification can be an audible notification or a notification identifying the source or content of the new message. Messages at or above a pre-defined priority are alerted to the receiving customer. The alerting can be by a screen message on a PC (Personal Computer), a screen message on a message phone, a special tone (different from a call waiting tone), or a special lamp. In response to receiving the alerting signal, the called customer can interrupt his/her conversation to investigate the message. Test 313 is used to deter-mine whether the new message has a preemption level. If so, then the user is warned that the new message will be delivered immediately unless the user specifically requests deferral of the new (preempting) message. Test 317 is used to determine whether the user has requested the deferral of the delivery of the new message within some short period of time. If the user has not requested such deferral, the new message is delivered. If the user has requested such deferral, the delivery of the message is deferred, and, because of the high precedence level of the new message, will be delivered as soon as the present message has been completed, (Action Block 321). If the new message does not have a preemption level, (negative result of Test 313), then Test 331 is used to determine whether the user wants to request immediate delivery of the new message. If so, then the new message is delivered immediately, (Action Block 333), and delivery of the earlier message is deferred until that new message has been delivered. If the user does not request immediate delivery, then no further action is required at this time, (Action Block 335), and the new message will be delivered in due course based on its position and precedence in the message queue of the output gateway.

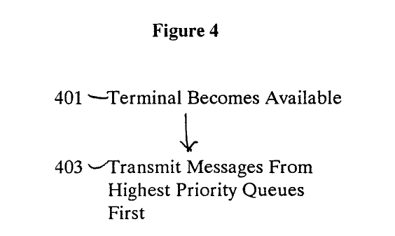

FIG. 4 is a flow diagram of the actions performed when a terminal goes from the idle state to the active state. The terminal becomes available, (Action Block 401). Messages that have been stored in the queue of the output gateway for that terminal are then transmitted with the highest precedence level queues being transmitted first.

The above is a description of one preferred embodiment of Applicants' invention. Many other embodiments will be apparent to those of ordinary skill in the art without departing from the scope of the invention. The invention is only limited by the attached Claims.

1. A method of delivering a plurality of data messages to a customer, comprising the steps of:
if the customer is idle, delivering a message directly to the customer;
if the customer is busy receiving another message, determining a precedence level for a received message, and storing the received message in storage associated with that precedence level;
if the customer is busy receiving said another message, notifying the customer that said message is being received by a system for storing received messages; and
subsequently, when the customer is idle, delivering messages to the customer from storage of higher precedence level before delivering messages from storage of lower precedence level.

2. The method of claim 1, wherein certain classes of messages also have a preemption level, wherein if said customer receives a message with a preemption level, the reception of said another message is interrupted if the precedence level of the received message is above a precedence level of said another message currently being received by the customer.

3. The method of claim 2, wherein the customer is first notified that the reception of said another message is about to be interrupted, and can signal that the customer does not wish to receive the preempting message before reception of said another message is completed.

4. The method of claim 1, further comprising the step of:
requesting immediate delivery of said received message.

5. The method of claim 1, wherein the step of notifying comprises the step of:
notifying only if the received message is at or above a predetermined precedence level.

6. A method of processing received voice calls, comprising the steps of:
determining whether the received voice call is one of a class defined by the receiving customer to be a call for which routing features are to be ignored; and
if so, completing the call ignoring routing features for the call.

7. Apparatus for delivering a plurality of data messages to a customer, comprising:
means, responsive to recognizing that the customer is idle, delivering a message directly to the customer;
means, responsive to recognizing that the customer is busy receiving another message, for determining a precedence level for a received message, and for storing the received message in storage associated with that precedence level;
means, responsive to recognizing that the customer is busy receiving said another message, for notifying the customer that said message is being received by a system for storing received messages; and
means for, subsequently, when the customer is idle, delivering messages to the customer from storage of higher precedence level before delivering messages from storage of lower precedence level.

8. The apparatus of claim 1, wherein certain classes of messages also have a preemption level, wherein if said customer receives a message with a preemption level, the reception of said another message is interrupted by said mean for delivering messages if the precedence level of the received message is above a precedence level of said another message currently being received by the customer.

9. The apparatus of claim 2, further comprising means for notifying the customer that the reception of said another message is about to be interrupted; and
means for signaling that the customer does not wish to receive the preempting message before reception of said another message is completed.

10. The apparatus of claim 1, further comprising means for requesting immediate delivery of said received message.

11. The apparatus of claim 1, wherein the means for notifying comprises means for notifying only if the received message is at or above a pre-determined precedence level.

12. Apparatus processing received voice calls, comprising:
means for determining whether the received voice call is one of a class defined by the receiving customer to be a call for which routing features are to be ignored; and
means, responsive to said means for determining, for completing the call ignoring routing features for the call.
